(19) United States
(12) Patent Application Publication
(10) Pub. No.: US 2026/0149148 A1
(43) Pub. Date: May 28, 2026

(54) BATTERY MODULE AND BATTERY PACK INCLUDING THE SAME

(71) Applicant: SK ON CO., LTD., Seoul (KR)

(72) Inventors: Yu Bin KANG, Daejeon (KR); Su A KIM, Daejeon (KR); Jin Woo SON, Daejeon (KR)

(21) Appl. No.: 19/390,676

(22) Filed: Nov. 17, 2025

(30) Foreign Application Priority Data
Nov. 26, 2024 (KR) 10-2024-0171467

(51) Int. Cl. H01M 50/588; H01M 10/653; H01M 10/658; H01M 50/258; H01M 50/271; H01M 50/593

(52) U.S. Cl. CPC H01M 50/588; H01M 10/653; H01M 10/658; H01M 50/258; H01M 50/271; H01M 50/593

(57) ABSTRACT

A battery module is disclosed. In some implementations, the battery module includes: a first sub-module and a second sub-module respectively including a plurality of battery cells; and a connection member disposed between the first sub-module and the second sub-module to connect the first sub-module and the second sub-module, wherein at least one of the first sub-module or the second sub-module includes a blocking member disposed between the connection member and the plurality of battery cells, and the blocking member protrudes beyond the connection member on at least one side.

### CROSS-REFERENCE TO RELATED APPLICATION(S)

This patent document claims the priority and benefits of Korean Patent Application No. 10-2024-0171467 filed on Nov. 26, 2024, the disclosure of which is incorporated herein by reference in its entirety.

### TECHNICAL FIELD

The disclosure and implementations disclosed in this patent document generally relate to a battery module and a battery pack including the same.

### BACKGROUND

Unlike a primary battery, a secondary battery has the convenience of being chargeable and dischargeable, and thus has received significant attention as a power source for various mobile devices, electric vehicles, or the like. Unlike a primary battery, a secondary battery may be chargeable and dischargeable, and thus be applied to devices within various fields such as digital cameras, mobile phones, laptop computers, hybrid vehicles, electric vehicles, and energy storage systems (ESSs).

Such a secondary battery may include a battery cell in which an electrode assembly is accommodated in a case, the electrode assembly being formed by stacking or winding in a roll form a positive electrode plate, a negative electrode plate, and a separator. The plurality of battery cells may be stacked in a predetermined direction and accommodated in a battery module or a battery pack.

Meanwhile, the plurality of battery cells may be stacked in the battery module or the battery pack, and accordingly, when thermal runaway occurs in any one battery cell, heat and flames may propagate to adjacent battery cells and cause a large fire or explosion.

Accordingly, technology for preventing heat or flames from propagating to adjacent battery cells has been importantly researched.

### SUMMARY

The present disclosure may be implemented in some embodiments to provide a battery module and a battery pack capable of preventing heat, flames, or gas occurring in any one sub-module from propagating to adjacent sub-modules.

The present disclosure may be implemented in some embodiments to provide a battery module and a battery pack capable of being easily attached to a housing through a flexible blocking member.

Meanwhile, the battery module and the battery pack according to the present disclosure may be widely applied to devices within green technology fields such as electric vehicles and battery charging stations, as well as solar power generation or wind power generation utilizing batteries. In addition, the battery module and the battery pack according to the present disclosure may be used for eco-friendly electric vehicles (EVs), hybrid vehicles, and the like for preventing climate change by suppressing air pollution and greenhouse gas emissions.

In some embodiments of the present disclosure, a battery module includes: a first sub-module and a second sub-module respectively including a cell unit including a plurality of battery cells; and a connection member disposed between the first sub-module and the second sub-module to connect the first sub-module and the second sub-module, wherein at least one of the first sub-module or the second sub-module includes a blocking member disposed between the connection member and the cell unit, and the blocking member protrudes beyond the connection member on at least one side.

Each of the first sub-module and the second sub-module may further include a side cover disposed on at least one side of the plurality of battery cells in a stacking direction of the plurality of battery cells, and the blocking member may protrude toward the side cover beyond the connection member to be inserted into the side cover.

The side cover may include a side insertion groove formed by at least partially recessing a surface of the side cover facing the cell unit, and at least a portion of the blocking member may be inserted into the side insertion groove.

The blocking member may protrude toward the side cover beyond the connection member by at least a first insertion length, and the first insertion length may be 0.3 mm to 0.7 mm.

The battery module may further include: a lower cover supporting the first sub-module and the second sub-module; and an upper cover disposed to face the lower cover while having the first sub-module and the second sub-module interposed therebetween, wherein the blocking member protrudes toward at least one of the lower cover or the upper cover beyond the connection member to be inserted into at least one of the upper cover or the lower cover.

At least one of the upper cover or the lower cover may include an upper insertion groove or a lower insertion groove formed by at least partially recessing a surface of the cover facing at least one of the first sub-module or the second sub-module, and at least a portion of the blocking member may be inserted into the upper insertion groove or the lower insertion groove.

The blocking member may protrude toward the upper cover beyond the connection member by a second insertion length to be inserted into the upper insertion groove, and the second insertion length may be 0.3 mm to 0.7 mm.

The blocking member may protrude toward the lower cover beyond the connection member by a third insertion length to be inserted into the lower insertion groove, and the third insertion length may be 0.3 mm to 0.7 mm.

The blocking member may include a material having at least one property of electrical insulation or heat resistance.

The blocking member may include at least one of mica, aerogel, glass fiber, silicate, graphite, aluminum, or ceramic wool.

A thermal conductivity of the blocking member may be 0.08 W/mK to 0.30 W/mK.

An insulation resistance of the blocking member may be 2.0×10³ MΩ to 3.5×10⁷ MΩ.

The blocking member may include a first blocking member disposed in the first sub-module and a second blocking member disposed in the second sub-module, and the first blocking member and the second blocking member may be disposed to face each other while having the connection member interposed therebetween.

The blocking member may satisfy at least one of an elastic recovery rate of 95% or more or a compression set of 2% to 4%.

In some embodiments of the present disclosure, provided is a battery pack including a pack case in which at least one battery module is disposed, wherein each of the at least one battery module includes a first sub-module and a second sub-module respectively including a plurality of battery cells, and a connection member disposed between the first sub-module and the second sub-module to connect the first sub-module and the second sub-module, at least one of the first sub-module or the second sub-module includes a blocking member disposed between the connection member and the plurality of battery cells, and the blocking member protrudes beyond the connection member on at least one side.

The battery pack may include: a lower cover supporting the first sub-module and the second sub-module; an upper cover disposed to face the lower cover while having the first sub-module and the second sub-module interposed therebetween; and a side cover disposed on at least one side of at least one of the first sub-module or the second sub-module, wherein the blocking member is inserted into at least one of the lower cover, the upper cover, or the side cover.

Although the solutions according to the present disclosure are described above, these solutions are merely exemplary, and it should be understood that even if other configurations not described are added thereto, such configurations fall within the scope of the present disclosure.

### BRIEF DESCRIPTION OF DRAWINGS

Certain aspects, features, and advantages of the present disclosure are illustrated by the following detailed description with reference to the accompanying drawings.

The present disclosure can be implemented in some embodiments to provide a battery module and a battery pack including the same.

FIG. 1 is a perspective view of a battery module according to an embodiment of the present disclosure.

FIG. 2 is an exploded view of the battery module according to an embodiment of the present disclosure.

FIG. 3 is an exploded view of a sub-module according to an embodiment of the present disclosure.

FIG. 4 is a view illustrating a connection between a first sub-module and a second sub-module.

FIG. 5 is a view illustrating a blocking member inserted into a side cover according to an embodiment.

FIG. 6 is a view illustrating the blocking member inserted into an upper cover and a lower cover according to an embodiment.

FIG. 7 is a perspective view of a battery pack according to an embodiment of the present disclosure.

### DETAILED DESCRIPTION

Features of the present disclosure disclosed in this patent document are described by example embodiments with reference to the accompanying drawings.

The present disclosure can be implemented in some embodiments to provide a battery module and a battery pack including the same.

Prior to providing a detailed description of the embodiments, it should not be construed that terms or words used in the following description and claims are limited to ordinary or dictionary meanings, and it should be interpreted as meanings and concepts conforming to the technical spirit of the present disclosure based on the principle that an inventor may properly define the concepts of terms in order to describe the inventor's invention by using the best method.

The same reference numerals or symbols described or illustrated in each drawing denote parts or components that perform substantially the same functions. For convenience of description and understanding, the same reference numerals or symbols may be used for description even in different embodiments.

In the following description, a term of a singular number includes its plural number unless clearly indicated otherwise in the context. Terms such as “include” or “comprise” are intended to specify the presence of features, numbers, steps, operations, components, parts, or combinations thereof described in the specification, and are not intended to preclude the possibility of presence or addition of one or more other features, numbers, steps, operations, components, parts, or combinations thereof.

In addition, in the following description, expressions such as upper side, upper portion, lower side, lower portion, side, front, and rear are expressed based on the directions illustrated in the drawings, and it is previously stated that such an expression may be expressed differently if a direction of the corresponding subject is changed.

In addition, in the following description and claims, terms including ordinals such as “first” and “second” may be used for distinction among components. Such ordinals are used to distinguish the same or similar components from each other, and should not be construed to limit meanings of terms due to the use of such ordinals. For example, components coupled with such ordinals should not be construed to be limited in use order or arrangement order by the numerals. If necessary, the respective ordinals may be interchanged and used.

Hereinafter, the present disclosure is described in detail with reference to the drawings.

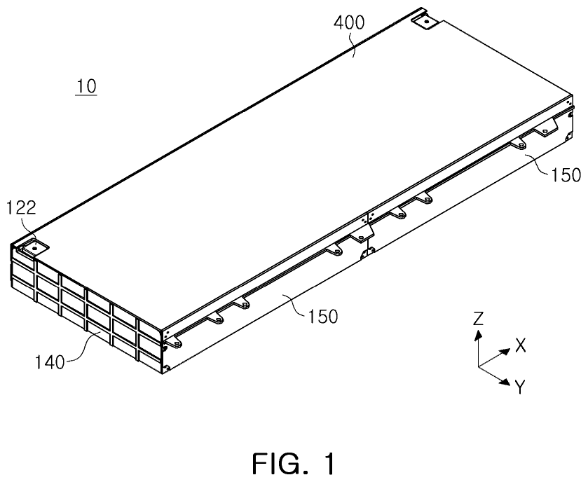

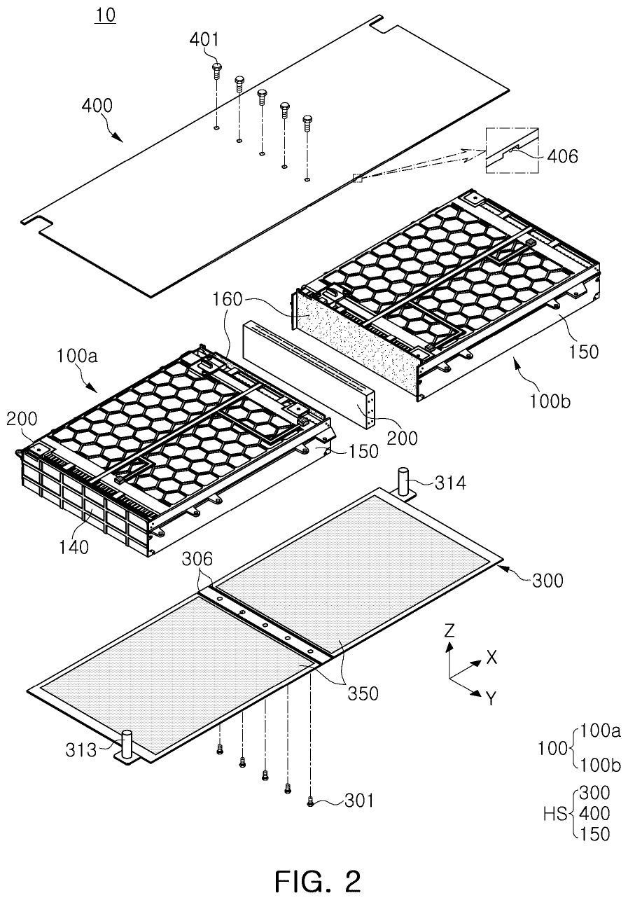

FIG. 1 is a perspective view of a battery module according to an embodiment of the present disclosure, and FIG. 2 is an exploded view of the battery module according to an embodiment of the present disclosure. A battery module 10 according to the present disclosure is described with reference to FIGS. 1 and 2.

The battery module 10 according to the present disclosure may include a plurality of sub-modules 100 respectively including a plurality of battery cells 111, a connection member 200 disposed between any two of the plurality of sub-modules 100, and upper and lower covers 400 and 300 respectively supporting upper and lower portions of the plurality of sub-modules 100. The battery module 10 according to an embodiment of the present disclosure may include a first sub-module 100a and a second sub-module 100b respectively including a cell unit 110 including the plurality of battery cells 111, and the connection member 200 disposed between the first sub-module 100a and the second sub-module 100b to connect the first sub-module 100a and the second sub-module 100b. Here, at least one of the first sub-module 100a or the second sub-module 100b may include a blocking member 160 disposed between the connection member 200 and the cell unit 110, and the blocking member 160 may protrude beyond the connection member 200 on at least one side.

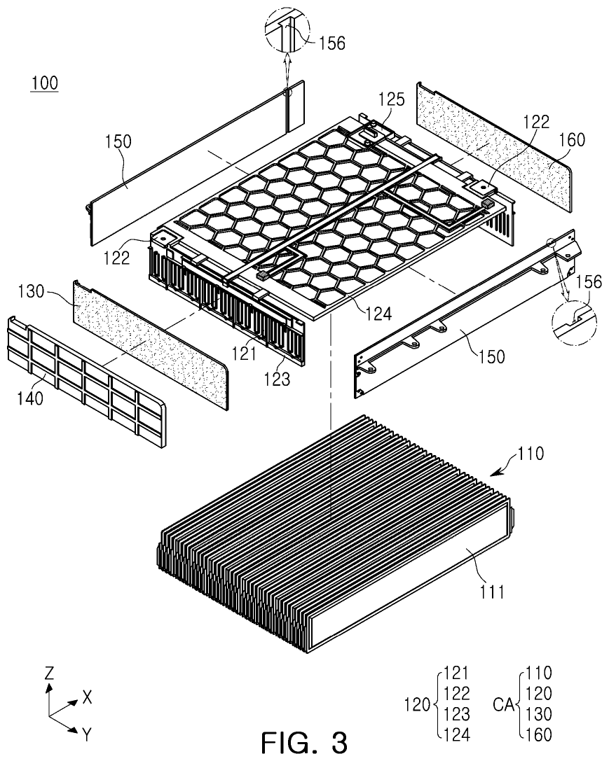

The plurality of sub-modules 100 may include the first sub-module 100a and the second sub-module 100b disposed adjacent to each other. For example, the first sub-module 100a and the second sub-module 100b may face each other in a length direction (i.e., an X-axis direction), and may be fixed to each other via the connection member 200 interposed therebetween. A configuration of the sub-module 100 is described below with reference to FIG. 3.

The connection member 200 may be disposed between two adjacent sub-modules 100 among the plurality of sub-modules 100 and may couple the two adjacent sub-modules 100 to each other. That is, the two adjacent sub-modules 100 may be fixed to each other via the connection member 200. In this way, the connection member 200 may serve as an assembly reference point among the sub-modules 100. That is, the connection member 200 may partition spaces in which the respective sub-modules 100 are accommodated in the battery module 10, and guide positions where the sub-modules 100 are disposed.

The connection member 200 may include a material having a predetermined rigidity to stably support the plurality of sub-modules 100. For example, the connection member 200 may include a metallic material such as aluminum or stainless steel.

The lower cover 300 may be disposed to support lower portions of the plurality of sub-modules 100. For example, the lower cover 300 may be integrally formed to support both the first sub-module 100a and the second sub-module 100b. In addition, according to an embodiment, the lower cover 300 may include a flow passage (not shown) therein, through which a cooling fluid flows. For example, the first sub-module 100a and the second sub-module 100b may be cooled through the flow passage. In addition, according to an embodiment, the lower cover 300 may include an inlet 313 through which the cooling fluid flows into the flow passage and an outlet 314 through which the cooling fluid in the flow passage is discharged. The lower cover 300 may be formed of a metallic material such as stainless steel to stably support and protect the plurality of sub-modules 100.

The upper cover 400 may be disposed to face the lower cover 300 to cover the plurality of sub-modules 100. For example, the upper cover 400 may be integrally formed to support both the first sub-module 100a and the second sub-module 100b. The upper cover 400 may be formed of the metallic material such as stainless steel to stably cover and protect the plurality of sub-modules 100.

In this way, the battery module 10 according to the present disclosure may stably protect the plurality of sub-modules 100 as one upper cover 400 and one lower cover 300, each of which is integrally formed, are disposed while having the plurality of sub-modules 100 interposed therebetween.

The upper cover 400 and the lower cover 300 may be coupled to the connection member 200 through fastening members 401 and 301, respectively.

At least one of the lower cover 300 or the upper cover 400 may be coupled to the connection member 200. For example, the upper cover 400 may be coupled to the connection member 200 through the upper fastening member 401, and the lower cover 300 may be coupled to the connection member 200 through the lower fastening member 301. In this way, the battery module 10 according to the present disclosure may improve assembly convenience and increase durability as the upper cover 400 and the lower cover 300 are coupled to each other via the connection member 200. However, a method of coupling the connection member 200 to the upper cover 400 or the lower cover 300 is not limited thereto.

Each sub-module 100 may include the plurality of battery cells to store or discharge electrical energy. In one battery module 10, the plurality of sub-modules 100 may be electrically connected to each other to output a design power value required for the battery module. For example, two sub-modules 100 facing each other while having the connection member 200 interposed therebetween may be connected in series or in parallel to each other through terminals. Conversely, in one battery module 10, the plurality of sub-modules 100 may be electrically separated from each other. For example, two sub-modules 100 facing each other while having the connection member 200 interposed therebetween may be electrically separated from each other, and the terminal of each sub-module 100 may be electrically connected to another adjacent battery module 10. However, this configuration is merely an example, and the present disclosure is not limited thereto. As long as the plurality of sub-modules 100 are included in the battery module 10 regardless of an electrical connection structure, all the plurality of sub-modules 100 may belong to the battery module 10 according to the present disclosure.

Hereinafter, the sub-module 100 according to the present disclosure is described in detail with reference to FIG. 3.

FIG. 3 is an exploded view of the sub-module according to an embodiment of the present disclosure. The sub-module 100 described with reference to FIG. 3 may correspond to any one of the first sub-module 100a or the second sub-module 100b described with reference to FIGS. 1 and 2, and a redundant description thereof is thus omitted.

The sub-module 100 may include the cell unit 110 including the plurality of battery cells 111, a bus bar assembly 120 electrically connected to the plurality of battery cells 111, a side cover 150 covering at least one side of the plurality of battery cells 111, an end cover 140 facing the connection member 200 while having the plurality of battery cells 111 interposed therebetween, an insulation cover 130 disposed between the end cover 140 and the cell unit 110, and a blocking member 160 disposed between the cell unit 110 and the connection member 200.

The cell unit 110 may include the plurality of battery cells 111 stacked in a predetermined direction. The battery cell 111 may include a case accommodating an electrode assembly. In the electrode assembly, a separator may be interposed between a positive electrode plate and a negative electrode plate stacked to have their wide surfaces facing each other. The separator may prevent electrical short-circuit occurring between the positive electrode plate and the negative electrode plate and allow a flow of ions. For example, the separator may include a porous polymer film or a porous nonwoven fabric. In addition, the electrode assembly may be accommodated in the case in various forms such as a jelly-roll type in which the electrode assembly is wound in a predetermined direction, a stacking type, a Z-folding type, or a stack-folding type. In addition, the battery cell 111 may be a lithium-ion secondary battery, and is not limited thereto. For example, the battery cell may be a nickel-cadmium battery, a nickel-metal hydride battery, or a nickel-hydrogen battery, all of which are chargeable and dischargeable. In addition, the battery cell 111 according to the present disclosure may be a pouch-type, a prismatic-type, or a cylindrical-type depending on a structure of the case accommodating the electrode assembly. In the drawings, the battery cell 111 is illustrated as a pouch cell in which the case is formed in a pouch shape. However, the present disclosure is not limited thereto, and prismatic or cylindrical types may also be used.

In addition, the cell unit 110 may further include a cell pad (not shown) disposed between the plurality of battery cells 111. The cell pad may include an elastic material to absorb swelling in which the battery cell 111 swells, or may include a heat-shielding material to prevent heat propagation between adjacent battery cells 111.

The bus bar assembly 120 may include a plurality of bus bars 121 electrically connecting the plurality of battery cells 111 of the cell unit 110 to each other, a support frame 123 supporting the bus bars, and electrode terminals 122 exposed externally and electrically connectable to an external power source. In addition, the bus bar assembly 120 may further include a sensor unit 124 sensing a state of the battery cell 111 such as its voltage or temperature.

The bus bar 121 may be disposed at least on one side of the cell unit 110. The bus bar 121 may be formed of a conductive material, and serve to electrically connect the plurality of battery cells 111 to each other. The bus bar 121 may be electrically connected to at least one of the plurality of battery cells 111 while being fixed to the support frame 123. At least some of the bus bars 121 may include the electrode terminals 122 electrically connectable to an external circuit of the sub-module 100.

The support frame 123 may structurally support the plurality of bus bars 121, and support the bus bars 121 to be stably connected to the battery cells 111. The support frame 123 may include a non-conductive material (e.g., plastic) having a predetermined rigidity. The support frame 123 may be disposed at least on one side of the cell unit 110. For example, the support frame 123 may be disposed on each of two sides of the cell unit 110 along the length direction (i.e., the X-axis direction). However, the present disclosure is not limited thereto.

The insulation cover 130 may be disposed between the bus bar assembly 120 and the end cover 140 forming one surface of the battery module 10 or the sub-module 100. The insulation cover 130 may include an electrically insulating material to prevent a short circuit from occurring between the bus bar assembly 120 and the end cover 140.

The blocking member 160 may protrude toward at least one side beyond the connection member 200 to be inserted into at least one of the side cover 150, the upper cover 400, or the lower cover 300, which is described below.

The blocking member 160 may be disposed between the cell unit 110 and the connection member 200. According to an embodiment of the present disclosure, the blocking member 160 may include a material satisfying at least one of electrical insulation or heat resistance. For example, the blocking member 160 may include at least one of mica, aerogel, silicate, glass fiber, or ceramic wool.

As described below, the blocking member 160 according to the present disclosure may protrude toward at least one side beyond the connection member 200.

Meanwhile, according to an embodiment, the blocking member 160 may include a material satisfying at least one of electrical insulation or heat resistance.

For example, the blocking member 160 may include a heat-resistant material having high thermal conductivity. In an embodiment, the thermal conductivity of the blocking member 160 according to the present disclosure may be 0.08 W/mK or more. If the thermal conductivity of the blocking member 160 is lower than 0.08 W/mK, heat may be easily conducted to an adjacent member (e.g., the connection member 200), thereby allowing heat to propagate between the sub-modules 100a and 100b.

In addition, in an embodiment, an upper limit of the thermal conductivity of the blocking member 160 may not be specifically limited to ensure the heat resistance. However, in consideration of practical manufacturing conditions such as a manufacturing cost and achievable thermal conductivity per 1 mm thickness, the thermal conductivity of the blocking member 160 may be 0.30 W/mK or less. If the thermal conductivity is greater than this value, the manufacturing cost may increase. Accordingly, according to an embodiment, the thermal conductivity of the blocking member 160 according to the present disclosure may be 0.08 W/mK to 0.30 W/mK. However, the blocking member 160 according to the present disclosure is not limited to such values of the thermal conductivity, and the blocking member 160 including any heat-resistant material may fall within the scope of the present disclosure.

In addition, according to an embodiment, an electrical insulation resistance of the blocking member 160 may be 2.0×10³ MΩ or more. If the insulation resistance of the blocking member 160 is lower than the corresponding value, insulation breakdown may occur, thus causing a short circuit between the adjacent sub-modules 100a and 100b or between the sub-module 100a or 100b and surrounding electric components.

In addition, an upper limit of the insulation resistance of the blocking member 160 according to an embodiment may not be specifically limited to ensure an insulation function. However, in consideration of the manufacturing cost, the insulation resistance may be limited to 3.5×10⁷ MΩ or less. Accordingly, according to an embodiment, the insulation resistance of the blocking member 160 according to the present disclosure may be 2.0×10³ MΩ to 3.5×10⁷ MΩ. However, the blocking member 160 according to the present disclosure is not limited to a material having the insulation resistance value described above. The blocking member 160 having such properties may not only prevent a short circuit occurring between the cell unit 110 or the bus bar assembly 120 and the connection member 200, but also prevent flames or gas from propagating to the adjacent sub-modules 100. However, the present disclosure is not limited thereto. That is, according to an embodiment, the blocking member 160 may include a material satisfying both the electrical insulation and the heat resistance. In this case, the thermal conductivity and insulation resistance of the blocking member 160 may satisfy the parameters described above.

Here, the blocking member 160 may be mica. Here, the blocking member 160 according to the present disclosure may be disposed between the cell unit 110 and the connection member 200 not only to prevent a short circuit occurring between the battery cell 111 or the bus bar assembly 120 and the connection member 200, but also to prevent flames occurring in any one sub-module 100 from propagating to the adjacent sub-modules 100. However, the present disclosure is not limited to the specific values described above.

In addition, according to an embodiment, the blocking member 160 may include a flexible material to be inserted while being bent into an insertion groove 156, 306, or 406 recessed in a housing HS (including the side cover 150, the lower cover 300, or the upper cover 400) described below. Meanwhile, the term “flexible” refers to being maintained in an inserted state in the insertion groove 156, 306, 406, and being at least partially bendable, and is not limited to specific numerical values.

For example, an elastic recovery rate of the blocking member 160 according to the present disclosure may be 90% or more. More specifically, the elastic recovery rate of the blocking member 160 may be 95% or more. If the elastic recovery rate is lower than the values described above, the blocking member 160 may not be restored to its original structure while being inserted into the side cover 150, or conversely, it may be difficult to insert the blocking member 160 while being bent into the insertion grooves 156, 306, or 406. In addition, the blocking member 160 having the elastic recovery rate described above may be inserted while being bent into or separated while being bent from the insertion groove 156, 306, or 406. In other words, the blocking member 160 may be at least partially inserted into at least one of the side insertion groove 156, the upper insertion groove 306, or the lower insertion groove 406.

In addition, a compression set of the blocking member 160 according to the present disclosure may be 5% or less. More specifically, the compression set of the blocking member 160 may be 2% to 4%. If the blocking member 160 has a compression set greater than the values described above, it may be difficult to insert or separate the blocking member 160 into or from the insertion groove 156, 306, or 406, and permanent deformation may occur during an insertion or separation process, thereby causing a gap or the like. On the other hand, the blocking member 160 having the compression set described above may not be significantly deformed even when inserted while being bent into the insertion groove 156, 306, or 406, and may effectively block a gap between the housing HS and the connection member 200. The blocking member 160 according to the example described above may fall within the scope of the present disclosure if the blocking member 160 satisfies at least one of the elastic recovery rate or the compression set described above.

Meanwhile, the present disclosure is not limited to the specific values of the elastic recovery rate, the compression set, the elastic modulus, or the like described above, and all the values may fall within the scope of the present disclosure as long as the blocking member 160 is inserted into the insertion groove 156, 306, or 406 without being damaged.

The end cover 140 may be disposed at an outermost portion of the sub-module 100 to form one surface of the sub-module 100 or the battery module 10. The end cover 140 may be disposed to face the connection member 200 or the blocking member 160 while having the cell unit 110 interposed therebetween. For example, referring to FIG. 2, the end cover 140 of the first sub-module 100a and the end cover 140 of the second sub-module 100b may be disposed to face each other while having the connection member 200 interposed therebetween, and may each form one surface of the battery module 10. The end cover 140 may include a rigid material (e.g., a metallic material such as aluminum) to protect the plurality of battery cells 111 from external impact.

The side cover 150 may be disposed at least on one side of the cell unit 110 to form at least one side surface of the sub-module 100 or the battery module 10. The side cover 150 may form the side surface of at least one of the plurality of sub-modules 100. In detail, the side cover 150 may be disposed on at least one of one side or the other side of the first sub-module 100a. In addition, the side cover 150 may be disposed on one side or the other side of the second sub-module 100b. In this way, the side cover 150 according to the present disclosure may be disposed on a lateral side in a stacking direction (i.e., a Y-axis direction) of the plurality of battery cells 111 to form the side surface of the sub-module 100. According to an embodiment, the side cover 150 may not only form the side surface of the sub-module 100 but also form at least portion of a side surface of the battery module 10. That is, according to an embodiment, the first and second sub-modules 100a and 100b may form one battery module 10 while the side cover 150 forms the side surface, and the first and second sub-modules 100a and 100b are connected to each other.

In this way, each sub-module 100 may be provided in a state in which the side cover 150 forms the side surface. In this state, the plurality of sub-modules 100 may be disposed to face each other, and the upper cover 300 and the lower cover 400 may be disposed above and below the plurality of sub-modules 100 to form one battery module 10.

According to an embodiment, the pair of side covers 150 may be provided and may be disposed on both sides of the cell unit 110 where the end cover 140 is not disposed. The side covers 150 may be disposed to face each other along the stacking direction (i.e., the Y-axis direction) of the plurality of battery cells 111. According to an embodiment, the side cover 150 may be coupled to the end cover 140 or the connection member 200 to form the side surface of the sub-module 100 or the battery module 10, thereby protecting the battery cell 111 from an external environment.

Meanwhile, according to an embodiment, the upper and lower portions of the sub-module 100 may be exposed, and may be covered by the lower cover 300 and the upper cover 400 covering two or more sub-modules 100 in a subsequent assembly step of the battery module 10.

According to an embodiment, the side cover 150 may face the cell unit 110 in a direction different from the end cover 140 to form another surface. For example, the pair of side covers 150 may be disposed to face each other in the stacking direction (i.e., the Y-axis direction) of the cell unit 110, and the end cover 140 and the blocking member 160 may face each other while having the cell unit 110 interposed therebetween. In this way, the end cover 140 and the pair of side covers 150 may form three surfaces of one sub-module 100, and the remaining one surface except for the upper and lower portions may be sealed by the blocking member 160 and then covered by the connection member 200. In this way, the lower portion of the sub-module 100 may be exposed to face a heat dissipation part 350 of the lower cover 300. That is, the plurality of battery cells 111 may be exposed downwardly to face the lower cover 300, thereby being rapidly cooled.

According to an embodiment of the present disclosure, the first sub-module 100a and the second sub-module 100b may be disposed to face each other in the length direction (i.e., the X-axis direction) while having the connection member 200 interposed therebetween. That is, the first sub-module 100a and the second sub-module 100b may share the connection member 200. Here, one surface of the respective sub-modules 100 facing each other may be sealed by the blocking member 160 and then covered by the connection member 200. In this way, one of the end covers 140 of the first sub-module 100a and the second sub-module 100b may form a front surface of the battery module 10, and the other may form a rear surface of the battery module 10. In addition, the first sub-module 100a and the second sub-module 100b may be coupled to each other via the connection member 200 while sharing the upper cover 400 and the lower cover 300.

Meanwhile, the battery module 10 according to the present disclosure may include a cell assembly CA. The cell assembly CA may be defined as a configuration of the sub-module 100 excluding the end cover 140, the side cover 150, or the like, which form an outer surface of the battery module 10. The cell assembly CA according to an embodiment may include the cell unit 110, the bus bar assembly 120, the insulation cover 130, and the blocking member 160. In addition, the battery module 10 according to the present disclosure may include the housing HS. In the present disclosure, the housing HS may be defined as a configuration of a cover forming an outer appearance of the battery module 10 that is coupled to the connection member 200. The housing HS according to an embodiment may include the side cover 150, the lower cover 300, and the upper cover 400.

According to an embodiment of the present disclosure, the blocking member 160 may protrude beyond the connection member 200 to be at least partially inserted into the housing HS. In other words, the blocking member 160 may be at least partially inserted into at least one of the side cover 150, the lower cover 300, or the upper cover 400. Through this structure, the battery module 10 according to the present disclosure may prevent flames or gas from propagating to the adjacent sub-modules 100 through the gap between the connection member 200 and the housing HS.

According to an embodiment, the blocking member 160 may protrude toward at least one side beyond the connection member 200 to be inserted into the side cover 150. In detail, according to an embodiment of the present disclosure, the side insertion groove 156 may be formed on an inner surface of the side cover 150 facing the cell unit 110. The insertion groove 156 may be formed by at least partially recessing the surface of the side cover 150 facing the battery cell 111 or the cell unit 110. The blocking member 160 may protrude beyond the cell unit 110 or the connection member 200 in the stacking direction (i.e., the Y-axis direction) of the battery cell to be inserted into the side insertion groove 156 of the side cover 150. In this way, flames or gas occurring in any one sub-module 100 may be prevented from propagating to the adjacent sub-modules 100 through the side cover 150. In addition, referring back to FIG. 2, at least one of the upper cover 400 or the lower cover 300 may include the upper insertion groove 406 or the lower insertion groove 306 formed by at least partially recessing the battery cell 111, i.e., a surface of the battery cell 111 facing the cell unit 110. The blocking member 160 may protrude upward or downward (i.e., in a Z-axis direction) beyond the connection member 200 to be inserted into at least one of the upper insertion groove 406 or the lower insertion groove 306. In this way, flames or gas occurring in any one sub-module 100 may be prevented from propagating to the adjacent sub-modules 100 through at least one of the upper cover 400 or the lower cover 300. According to an embodiment, after the pair of side covers 150 are assembled, the blocking member 160 may be bent and inserted into at least one of the side insertion groove 156, the upper insertion groove 406, or the lower insertion groove 306.

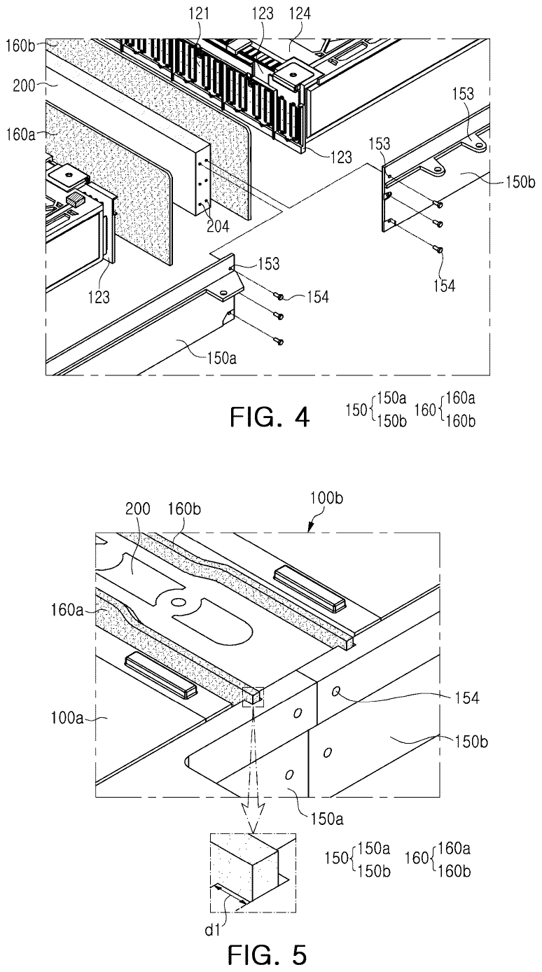

Hereinafter, a structure for coupling the plurality of sub-modules 100 to each other is described with reference to FIGS. 4 and 5.

FIG. 4 is a view illustrating a connection between the first sub-module and the second sub-module, and FIG. 5 is a view illustrating the blocking member inserted into the side cover according to an embodiment.

Referring to FIG. 4, the connection member 200 may be coupled to the side cover 150 through a side fastening member 154. For example, the side cover 150 of the first sub-module 100a (hereinafter, a first side cover 150a) and the side cover 150 of the second sub-module 100b (hereinafter, a second side cover 150b) may protrude in the length direction (i.e., the X-axis direction) beyond the blocking member 160 of the first sub-module 100a (hereinafter, a first blocking member 160a) and the blocking member 160 of the second sub-module 100b (hereinafter, a second blocking member 160 b), respectively, to at least partially overlap the connection member 200 in the stacking direction (i.e., the Y-axis direction) of the battery cells. For example, The two adjacent side covers 150, i.e., the side cover 150a of the first sub-module 100a and the side cover 150b of the second sub-module 100b, may be fixed to each other via the connection member 200 as the side fastening members 154 are inserted into a connection fastening hole 204 and a side fastening hole 153, respectively.

Referring to FIG. 5, the blocking member 160 may protrude beyond the connection member 200 to allow its side end to be inserted into the side insertion groove 156. For example, the blocking member 160a of the first sub-module 100a may be inserted into the first side cover 150 a, and the blocking member 160 b of the second sub-module 100b may be inserted into the second side cover 150b, respectively, and the first side cover 150a and the side cover 150b may be coupled to each other via the connection member 200.

According to an embodiment, the blocking member 160 may be inserted into the side cover 150 by a first insertion length d1. For example, the blocking member 160 may protrude beyond the connection member 200 by at least the first insertion length d1 to be inserted into the side insertion groove 156. For example, when considering assembly tolerance, the first insertion length d1 may be 0.3 mm to 0.7 mm. However, the present disclosure is not limited to such specific values, and the above value may vary depending on a thickness of the side cover 150.

Meanwhile, in the drawings, only the side cover 150 of one side is illustrated. However, the present disclosure is not limited thereto. That is, if the side cover 150 is disposed on at least one side and the blocking member 160 is inserted into at least one side cover 150, all such configurations may fall within the scope of the present disclosure.

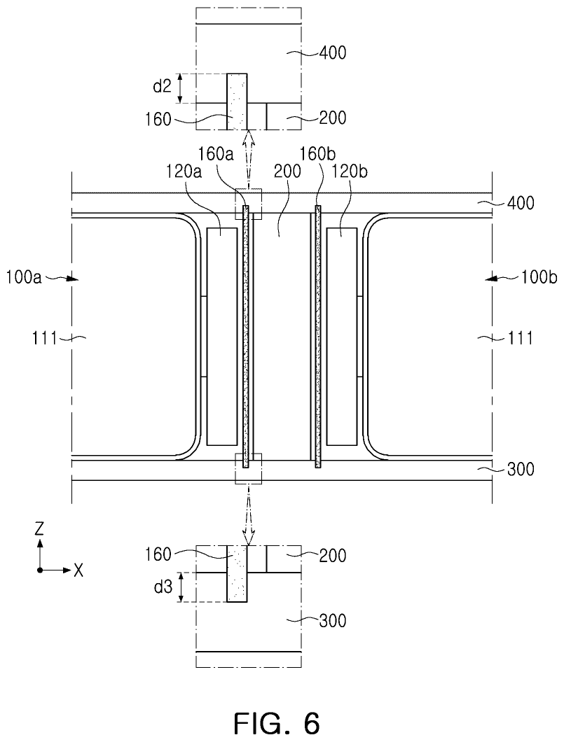

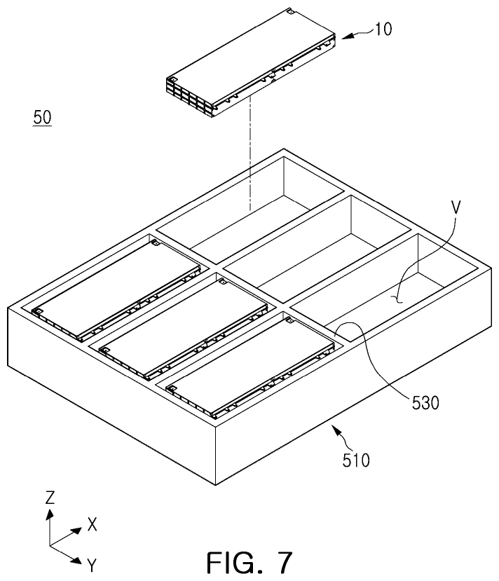

Hereinafter, a cross-sectional structure of the battery module 10 in a state in which the blocking member 160 is inserted into the upper cover 400 and the lower cover 300 is described with reference to FIG. 6.

FIG. 6 is a view illustrating the blocking member inserted into the upper cover or the lower cover according to an embodiment. Referring to FIG. 6, the blocking member 160 may protrude beyond the connection member 200 in the height direction (i.e., the Z-axis direction) to be inserted into at least one of the upper cover 400 or the lower cover 300. In detail, the upper cover 400 or the lower cover 300 may include the upper insertion groove 406 or the lower insertion groove 306 formed by recessing a surface of the cover facing the first sub-module 100a or the second sub-module 100b, and the blocking member 160 may be at least partially inserted into the upper insertion groove 406 or the lower insertion groove 306.

The blocking member 160 may be inserted into the upper cover 400 by a second insertion length d2. Here, the blocking member 160 may protrude upward (i.e., in a +Z-axis direction) beyond the connection member 200 by at least the second insertion length d2. In addition, the blocking member 160 may be inserted into the lower cover 300 by a third insertion length d3. Here, the blocking member 160 may protrude downward (i.e., in a −Z-axis direction) beyond the connection member 200 by at least the third insertion length d3.

For example, the second insertion length d2 and the third insertion length d3 may approximately correspond to the first insertion length d1. For example, each of the second insertion length d2 and the third insertion length d3 may be 0.3 mm to 0.7 mm. However, the insertion lengths d1, d2, and d3 according to the present disclosure are not limited to such specific values.

According to an embodiment, the blocking members 160a and 160b may be disposed to face each other while having the connection member 200 interposed therebetween, thereby preventing heat from propagating between the sub-modules 100. That is, in the battery module 10 according to the present disclosure, the blocking members 160 of two sub-modules 100 facing each other while having the connection member 200 therebetween may be inserted into the housing HS, thereby preventing or at least delaying fire occurring in either one sub-module from spreading to the other sub-module.

A battery pack 50 according to the present disclosure may include at least one battery module 10 described with reference to FIGS. 1 to 6. Hereinafter, the battery pack 50 according to the present disclosure is described.

FIG. 7 is a perspective view of the battery pack according to an embodiment of the present disclosure. A battery module 10 described with reference to FIG. 7 corresponds to the battery module 10 illustrated in FIGS. 1 to 6, and a redundant description thereof is thus omitted.

Referring to FIG. 7, the battery pack 50 according to an embodiment of the present disclosure may include a pack case 510, a partition wall 530 partitioning the interior of the pack case 510 into a plurality of loading spaces V, and at least one battery module 100 loaded in the loading space V.

Meanwhile, the battery pack 50 according to the present disclosure is not limited to the number of battery modules 100 accommodated therein or the presence or absence of the partition wall 530. That is, all the battery packs 50 including the pack case 510 accommodating at least one battery module 10 may fall within the scope of the present disclosure.

As set forth above, the battery module and the battery pack according to an embodiment of the present disclosure may prevent heat, flames, or gas occurring in any one sub-module from propagating to the adjacent sub-modules.

The battery module and the battery pack according to an embodiment of the present disclosure may be easily attached to the housing through the flexible blocking member.

Only specific examples of implementations of certain embodiments are described. Variations, improvements and enhancements of the disclosed embodiments and other embodiments may be made based on the present disclosure of this patent document.

What is claimed is:

1. A battery module comprising:
a first sub-module and a second sub-module respectively including a cell unit including a plurality of battery cells; and
a connection member disposed between the first sub-module and the second sub-module to connect the first sub-module and the second sub-module,
wherein at least one of the first sub-module or the second sub-module includes a blocking member disposed between the connection member and the cell unit, and
the blocking member protrudes beyond the connection member on at least one side.

2. The battery module of claim 1, wherein each of the first sub-module and the second sub-module further includes a side cover disposed on at least one side of the plurality of battery cells in a stacking direction of the plurality of battery cells, and
the blocking member protrudes toward the side cover beyond the connection member to be inserted into the side cover.

3. The battery module of claim 2, wherein the side cover includes a side insertion groove formed by at least partially recessing a surface of the side cover facing the cell unit, and
at least a portion of the blocking member is inserted into the side insertion groove.

4. The battery module of claim 3, wherein the blocking member protrudes toward the side cover beyond the connection member by at least a first insertion length, and
the first insertion length is 0.3 mm to 0.7 mm.

5. The battery module of claim 1, further comprising:
a lower cover supporting the first sub-module and the second sub-module; and
an upper cover disposed to face the lower cover while having the first sub-module and the second sub-module interposed therebetween,
wherein the blocking member protrudes toward at least one of the lower cover or the upper cover beyond the connection member to be inserted into at least one of the upper cover or the lower cover.

6. The battery module of claim 5, wherein at least one of the upper cover or the lower cover includes an upper insertion groove or a lower insertion groove formed by at least partially recessing a surface of the cover facing at least one of the first sub-module or the second sub-module, and
at least a portion of the blocking member is inserted into the upper insertion groove or the lower insertion groove.

7. The battery module of claim 6, wherein the blocking member protrudes toward the upper cover beyond the connection member by a second insertion length to be inserted into the upper insertion groove, and
the second insertion length is 0.3 mm to 0.7 mm.

8. The battery module of claim 6, wherein the blocking member protrudes toward the lower cover beyond the connection member by a third insertion length to be inserted into the lower insertion groove, and
the third insertion length is 0.3 mm to 0.7 mm.

9. The battery module of claim 1, wherein the blocking member includes a material having at least one property of electrical insulation or heat resistance.

10. The battery module of claim 1, wherein the blocking member includes at least one of mica, aerogel, glass fiber, silicate, graphite, aluminum, or ceramic wool.

11. The battery module of claim 1, wherein a thermal conductivity of the blocking member is 0.08 W/mK to 0.30 W/mK.

12. The battery module of claim 1, wherein an insulation resistance of the blocking member is 2.0×10³ MΩ to 3.5×10⁷ MΩ.

13. The battery module of claim 1, wherein the blocking member includes a first blocking member disposed in the first sub-module and a second blocking member disposed in the second sub-module, and
the first blocking member and the second blocking member are disposed to face each other while having the connection member interposed therebetween.

14. The battery module of claim 1, wherein the blocking member satisfies at least one of an elastic recovery rate of 95% or more or a compression set of 2% to 4%.

15. A battery pack comprising a pack case in which at least one battery module is disposed, wherein
each of the at least one battery module includes
a first sub-module and a second sub-module respectively including a plurality of battery cells, and
a connection member disposed between the first sub-module and the second sub-module to connect the first sub-module and the second sub-module,
at least one of the first sub-module or the second sub-module includes a blocking member disposed between the connection member and the plurality of battery cells, and
the blocking member protrudes beyond the connection member on at least one side.

16. The battery pack of claim 15, comprising:
a lower cover supporting the first sub-module and the second sub-module;
an upper cover disposed to face the lower cover while having the first sub-module and the second sub-module interposed therebetween; and
a side cover disposed on at least one side of at least one of the first sub-module or the second sub-module,
wherein the blocking member is inserted into at least one of the lower cover, the upper cover, or the side cover.
